(19) United States
(12) Patent Application Publication
(10) Pub. No.: US 2025/0006168 A1
(43) Pub. Date: Jan. 2, 2025

(54) OCCLUSION AND NOISE CANCELLATION SYSTEMS AND METHODS FOR HEARING DEVICES

(71) Applicant: GN Hearing A/S, Ballerup (DK)

(72) Inventors: Andreas TIEFENAU, Gammel Holte (DK); Erik Cornelis Diederik VAN DER WERF, Eindhoven (NL)

(73) Assignee: GN Hearing A/S, Ballerup (DK)

(21) Appl. No.: 18/679,146

(22) Filed: May 30, 2024

(30) Foreign Application Priority Data
Jun. 28, 2023 (EP) 23182084.6

(51) Int. Cl. G10K 11/178; H04R 25/00

(52) U.S. Cl. CPC G10K 11/17815; G10K 11/17823; G10K 11/17825; G10K 11/17881; H04R 25/604; G10K 2210/1081; G10K 2210/3018; G10K 2210/3026; G10K 2210/3027; G10K 2210/3028; G10K 2210/3055; H04R 2460/01

(57) ABSTRACT

The present disclosure relates to a hearing device that comprises an in-canal microphone configured for pick-up of at least body conducted sound in a user's ear canal volume and a vibration sensor configured for pick-up of mechanical vibration generated by body-conducted sound of the user for example by vibration of ear canal tissue. A processing unit of the hearing device determines a first compensation signal for cancelling the at least body-conducted sound in the user's ear canal volume based on sound picked-up by the in-canal microphone. The processing unit determines a second compensation signal for cancelling the at least body-conducted sound in the user's ear canal volume based on a vibration signal supplied by the vibration sensor.

### RELATED APPLICATION DATA

This application claims priority to, and the benefit of, European Patent Application No. 23182084.6 filed on Jun. 28, 2023, pending. The entire disclosure of the above application is expressly incorporated by reference herein.

### FIELD

The present disclosure relates to hearing devices that comprises an in-canal microphone configured for pick-up of at least body conducted sound in a user's ear canal volume and a vibration sensor configured for pick-up of mechanical vibration generated by the body-conducted sound of the user for example by vibration of ear canal tissue. A processing unit of the hearing device determines a first compensation signal for cancelling the at least body-conducted sound in the user's ear canal volume based on sound picked-up by the in-canal microphone. The processing unit of the hearing device determines a second compensation signal for cancelling the at least body-conducted sound in the user's ear canal volume based on a vibration signal supplied by the vibration sensor.

### BACKGROUND

The occlusion effect is the unnatural perception of by the user of his/hers own voice caused by inserting a housing such as a mould or a shell into the user's ear canal. This arrangement of housing leads to a part or full blocking the user' ear canal and thereby leave an at least partly occluded ear canal volume in-front of the user's eardrum.

Depending on individual geometry of the user's ear canal the occlusion effect may cause low frequency amplification up to 30 dB where the effect is most pronounced for frequencies below about 500 Hz. The occlusion problem has historically been mitigated by provision of hearing devices with so-called open fittings where a sound path around or through the housing is deliberately included. However, there are numerous fitting situations where open fittings are unfeasible, e.g., due to gain or output power limitations, or when the ear canal must be sealed for protective purposes. Active Occlusion Cancellation (AOC) has proved a viable alternative to open fittings. AOC uses adaptive filters to reduce the occlusion effect by calculation of a compensation signal that is added to a receiver input. The role of the compensation signal is to suppress or cancel the undesired (low) frequency sound in the ear canal of the user.

EP 3 340 653 B1 discloses a hearing device with an AOC circuit which comprises a first adaptive filter and a second adaptive filter. The first adaptive filter is arranged inside a feedback path of the AOC circuit and utilizes an ear canal audio signal sensed by ear canal microphone. The latter detects sound pressure in a user's occluded ear canal volume.

### SUMMARY

A first aspect of the disclosure relates to hearing device (50) comprising:
an ambient microphone configured for pick-up of ambient sound at a user's ear and respond by generating an ambient audio signal (x1),
an in-canal microphone configured for pick-up of sound in an ear canal volume in front the user's tympanic membrane comprising body conducted sound and respond by generating an in-canal audio signal,
a vibration sensor configured for pick-up of mechanical vibration generated by at least the body-conducted sound of the user and respond by generating a vibration signal,
a processing unit configured to process the ambient audio signal (x1) in accordance with a predetermined signal processing algorithm to generate a processed audio signal (u),
a receiver configured for emission of output sound into the user's ear canal volume in response to a receiver input; and
a feedback path comprising a first filter configured to supply at first compensation signal for cancelling at least the body-conducted sound in the user's ear canal volume based on the in-canal audio signal,
a second filter configured to model a transfer function from the receiver input to the in-canal audio signal of the in-canal microphone,
a feedforward path comprising a third filter configured to supply a second compensation signal for cancelling at least the body-conducted sound in the user's ear canal volume based on the vibration signal.

The processing unit may comprise a digital signal processor (DSP) and/or a microprocessor such as a software programmable DSP or a software programmable microprocessor. The software programmable DSP or microprocessor may be configured to execute a plurality of program instructions configured to implement at least a part of the signal processing algorithms, functions, steps and features of the hearing device according to the first and second aspects of the disclosure, in particular those associated with an active occlusion cancellation or suppression (AOC) arrangement, and optionally noise cancellation or suppression, of the hearing device as described in detail below with reference to the appended drawings. The processing unit may additionally comprise one or more dedicated e.g. hard-coded digital state machine(s) configured to handle certain signal processing functions for example of the AOC arrangement as described in detail below with reference to the appended drawings.

An embodiment of the hearing device further comprises:
a fourth filter configured to supply a third compensation signal for cancelling noise sound transmitted into the user's ear canal volume, such as via acoustic leakage around a housing of the hearing device or via the ambient audio signal, based on the ambient microphone signal.

The skilled person will understand that utilization of at least two distinct compensation signals, the in-canal audio signal, that is derived from sound sensed in the user's ear canal volume, and the vibration signal, that is derived from mechanical tissue vibration caused by body-conducted sound, represent different and e.g. complementary estimates of the undesired body-conducted sound in the user's ear canal volume. The accuracy of the estimate of the body-conducted sound in the ear canal volume is improved by such utilization of at least two distinct compensation signals to provide improved cancellation of the body-conducted sound in the user's ear canal volume for numerous reasons as described in additional detail below with reference to the appended drawings.

In some embodiments at least one of the first filter, the second filter, the third filter and the fourth filter may stay fixed during normal operation of the hearing device and instead adjusted or adapted off-line for example during manufacturing of the hearing device or during an initialization phase of the hearing device and its AOC arrangement at a dispenser's office in connection with initial fitting of the hearing device to the user. The initialization of the least one of the first filter, the second filter, the third filter and the fourth filter may alternatively be carried out by the processing unit at power-on of the hearing device where after the least one of the first filter, the second filter, the third filter and the fourth filter remains fixed during normal operation of the hearing device. In other embodiments, the least one of the first filter, the second filter, the third filter and the fourth filter is adapted during normal operation of the hearing device, i.e. an adaptive filter. The adaptation of the at least one of the first filter, the second filter, the third filter and the fourth filter may comprise computing and repeatedly update a plurality of filter coefficients of the least one of the first filter, the second filter, the third filter and the fourth filter in accordance with an optimization algorithm such as LMS, NMLS, etc.

The initialization phase of the at least one of the first filter, the second filter, the third filter and the fourth filter may comprise injecting a probe signal, such as a random noise signal or noise sequence, into the ambient microphone and/in-canal microphone and/or the vibration sensor of the hearing device to determine a transfer function estimate of the least one of the first filter, the second filter, the third filter and the fourth filter.

According to an embodiment of the hearing device, the processing unit is configured to:
subtract the first compensation signal from the processed audio signal (u) by a first subtractor,
subtract the second compensation signal from the processed audio signal (u) by the first subtractor and
apply an output of the first subtractor to the receiver input.

According to an embodiment of the hearing device, the processing unit comprises a second subtractor comprising an output configured to generate an error signal (v′) by subtracting:

an output of the second filter from the in-canal audio signal (m); and apply the error signal (v′) to an input of the first filter.

According to an embodiment of the hearing device the first subtractor is configured to subtract the third compensation signal from the processed audio signal (u).

According to an embodiment of the hearing device the processing unit is configured to minimize energy or power of the error signal (v′) over a predetermined frequency range such as above 50 Hz or between 20 Hz and 1 kHz for example between 100 Hz and 400 Hz.

According to an embodiment of the hearing device the processing unit is configured to minimize the energy or power of the error signal (v′) by:
adapt or adjust a transfer function of the first filter to maximize a real part of (1+B*R),
adapt or adjust a transfer function of the second filter to minimize the error signal (v′),
adapt or adjust a transfer function of the third filter to minimize the error signal (v′); and optionally
adapt or adjust a transfer function of the fourth filter to minimize the error signal (v′), wherein
B: is a transfer function of the first filter;
R: is a transfer function from the receiver input (y) to the in-canal audio signal (m).

According to an embodiment of the hearing device the processing unit is configured to minimize the energy or power of the error signal (v′) by minimizing a norm of the error signal (v′) such as a 1-norm or a 2-norm; wherein the error signal (v′) is represented according to equation (1)

$$\frac{( ( R - A ) G + \frac{H 2}{H 1} - CR ) {x}_{1} + ( \frac{H 4}{H 3} - DR ) {x}_{2}}{1 + BR}$$

wherein:
A: is a transfer function of the second filter;
B: is the transfer function of the first filter;
C: is a transfer function of the third filter;
D: is a transfer function of the fourth filter;
G: is the transfer function of the processing unit:
R: is the transfer function from the receiver input to the in-canal audio signal (m);
H1: is a transfer function from the ambient sound to the ambient audio signal (x1);
H2: is a transfer function from the ambient sound to the ear canal microphone signal (m);
H3: is a transfer function from a source of the vibration signal, e.g. the user's vocal cords, to the vibration sensor signal (x2);
H4: is a transfer function from the vibration source to the ear canal microphone (m)

According to an embodiment of the hearing device the processing unit is configured to adapt the transfer function of the first filter and adapt the transfer function of the third filter during normal operation of the hearing device. The processing unit may be configured to keep the transfer function of the second filter fixed, i.e. no adaptation of the transfer function, during normal operation of the hearing device. According to certain embodiments of the hearing device the processing unit is configured to adapt the transfer function of the fourth filter during normal operation of the hearing device.

The skilled person will appreciate that the adaptation of one or more filters of the hearing device during normal operation often will lead to superior occlusion and/or noise cancellation of the AOC arrangement hearing device because the respective estimates of the transfer functions of the first, second, third and fourth filter may possess superior accuracy because of the ability to track time-changing electro-mechanical and acoustical characteristics of the hearing device in-situ as mounted on the user.

According to an embodiment of the hearing device the processing unit is configured to:
adapting the transfer function of the second filter by cross-correlating the processed audio signal (u) and the error signal (v′) to calculate a first gradient direction,
apply the first gradient direction in a first optimization algorithm such as LMS or NLMS; and
adapting the transfer function of the third filter by filtering the vibration signal (x2) with the transfer function of the second filter to provide a processed output signal,
cross-correlating the processed output signal and the error signal (v′) to calculate a second gradient direction; and
apply the second gradient direction in a second optimization algorithm such as LMS or NLMS.

Various exemplary embodiments of the hearing device comprises a housing such as a housing shaped and sized for partly or fully placement in the user's ear canal. The housing comprising:
an exteriorly oriented surface comprising a sound inlet (of the ambient microphone,
an interiorly oriented tip facing the user's ear canal volume (65) and supporting a sound outlet of the receiver,
a side surface configured to make a vibration sensitive section of the vibration sensor physically contact the user's ear canal during normal use of the hearing device.

A second aspect of the disclosure relates to a method of suppressing at least body-conducted sound in an ear canal volume of a user of a hearing device, comprising:
pick-up of ambient sound at the user's ear to generate a corresponding ambient audio signal (x1),
process the ambient audio signal (x1) in accordance with a predetermined signal processing algorithm to generate a processed audio signal (u),
pick-up sound in the ear canal volume by an in-canal microphone to generate a corresponding in-canal audio signal (m), wherein said sound in the ear canal volume comprises at least body-conducted sound,
pick-up, by vibration sensor, mechanical vibration of ear canal tissue of the user and generate a corresponding vibration signal (x2),
emit output sound into the user's ear canal volume by a receiver in response to a receiver input (y),
cancel at least the body-conducted sound in the user's ear canal volume (65) by a first compensation signal generated by a first filter of a feedback path based on the in-canal audio signal (m),
adjusting or adapting a second filter to model a transfer function (R) from the receiver input (y) to the in-canal audio signal (m) of the in-canal microphone,
cancel at least the body-conducted sound in the user's ear canal volume by a second compensation signal generated by a third filter of a feedforward signal path based on the vibration signal (x2).

One embodiment of the method of suppressing at least body-conducted sound in an ear canal volume comprises the generation of the receiver input (y) by:
subtract the first compensation signal from the processed audio signal (u),
subtract the second compensation signal from the processed audio signal (u).

One embodiment of the method of suppressing at least body-conducted sound in an ear canal volume comprises adapting a plurality of filter coefficients of the third filter during initialization of the hearing device and/or during normal operation of the hearing device and adapting a plurality of filter coefficients of the first filter during initialization of the hearing device and/or during normal operation of the hearing device.

One embodiment of the method of suppressing at least body-conducted sound in an ear canal volume comprises:
place the hearing device in normal operation which comprises processing of the ambient audio signal (x1) and emission of the corresponding receiver output sound when the hearing device is mounted in or at the user's ear;
simultaneously or parallelly adapt the respective transfer functions of the first filter and the third filter and optionally adapt the transfer function of the fourth filter.

### BRIEF DESCRIPTION OF THE DRAWINGS

Other and further aspects and features will be evident from reading the following detailed description of the embodiments.

The drawings illustrate the design and utility of embodiments of the hearing device, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 shows a schematic drawing of an exemplary hearing device comprising an active occlusion suppression arrangement or circuit in accordance with embodiments,

FIG. 2 shows a block diagram of the exemplary hearing device including details of the active occlusion suppression circuit or arrangement,

FIG. 3 shows in schematic format a first embodiment of the exemplary hearing device 50 including certain computational models and functions and algorithms of the active occlusion suppression circuit or arrangement,

FIG. 3A shows in schematic format a second embodiment of the exemplary hearing device including certain computational models, functions and algorithms of the active occlusion suppression circuit or arrangement; and

FIG. 4 and FIG. 5 jointly show a block diagram of certain exemplary embodiments of adaptive filters, functions and algorithms of the exemplary hearing device.

### DETAILED DESCRIPTION

Various exemplary embodiments of hearing device and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

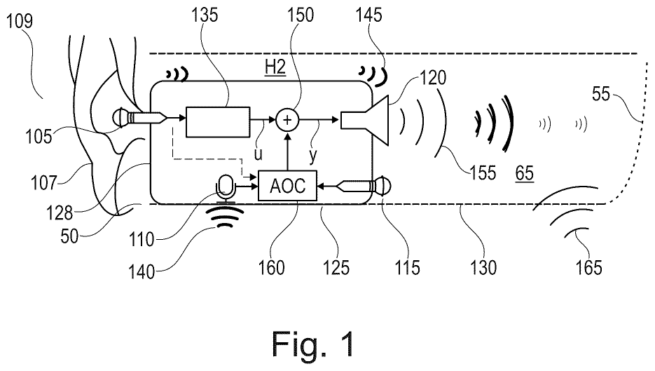

FIG. 1 shows a schematic drawing of the exemplary hearing device 50. The hearing device 50 comprises an ambient microphone 105 for pick-up of ambient sound at the hearing device 50 when mounted at, in or on a hearing device user's ear 107. The ambient microphone 105 responds to the ambient sound by generating an ambient audio signal. The ambient audio signal is preferably sampled and digitized in an A/D converter (not shown) before further processing in a digital domain. The A/D converter may be integrated within a housing of the ambient microphone or integrated on a common semiconductor substrate with a processing unit 135.

The hearing device 50 comprises an in-canal microphone 115 configured for pick-up, detection or receipt of sound in a fully or partly occluded ear canal volume 65 in front the user's tympanic membrane 55. The in-canal microphone 115 responds to the sound picked-up in the ear canal volume 65 by generating an in-canal audio signal. The in-canal audio signal is preferably sampled and digitized in an A/D converter (not shown) in a similar manner to the ambient audio signal.

The hearing device 50 further comprises a vibration sensor 110 configured for pick-up or detection of mechanical vibration 140 generated by body-conducted sound 165 of the user for example by vibration of ear canal tissue 130. The vibration sensor 110 responds to the mechanical vibration 140 by generating a vibration signal that preferably is sampled and digitized in an A/D converter (not shown) in a similar manner to the ambient audio signal.

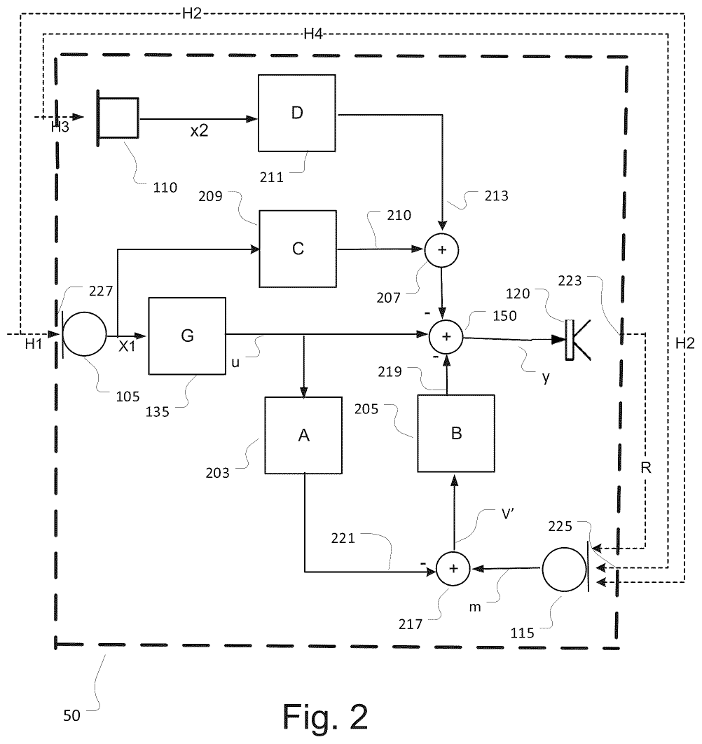

The hearing device 50 further comprises a receiver 120 such as, a miniature loudspeaker, configured for emission of output sound 155 into the user's ear canal volume 65 in response to a receiver input (y). The receiver 120 may comprise a moving armature loudspeaker, a piezoelectric loudspeaker or dynamic loudspeaker etc. The receiver input (y) is generated by an output of a first subtractor 150 configured to supply the receiver input by subtraction of certain compensation signals delivered by a schematically illustrated active occlusion cancellation or suppression arrangement 160 as discussed in further detail below inter alia with reference to FIG. 2. The housing 125 may comprise a sound inlet (227 on FIG. 2) leading to a sound port of the ambient microphone 105. The sound inlet 227 may be arranged in an exterior oriented surface 128 of the housing oriented outwardly of the user's ear canal 130 towards the external sound environment. The housing 125 may further comprise an interior oriented tip facing the user's ear canal volume 65 and supporting a sound outlet (223 on FIG. 2) of the receiver 120. The housing 125 may comprise a side surface configured to make a vibration sensitive wall or membrane of the vibration sensor 110 physically contact the user's ear canal. A good mechanical fit or contact between tissue of the user's ear canal 130 and the vibration sensitive membrane may be advantageous for accurate sensing of the vibration caused by the body-conducted sound.

The processing unit 135 is configured to process the ambient audio signal in accordance with one or more predetermined signal processing algorithm(s) to generate a processed audio signal (u) at an output of the processing unit 135. The processing unit 135 may comprise a digital signal processor (DSP) and/or a microprocessor such as a software programmable DSP or a software programmable microprocessor. The software programmable DSP or microprocessor may be configured to execute a plurality of program instructions configured to implement at least a part of the signal processing algorithms, functions, steps and features of the hearing device 50 described in detail below. The processing unit 135 may additionally comprise one or more dedicated e.g. hard-coded digital state machine(s) configured to handle certain signal processing algorithms, such as fixed filter processing or adaptive filter processing and/or other functions, steps and features of the hearing device 50. The processing unit 135 may accordingly be configured to carry out certain computations of respective filter coefficients of one or more adaptive filters such as those of an adaptive filter of a feedback path configured to suppress or cancel at least body-conducted sound in the user's ear canal volume 65 based on an in-canal audio signal supplied by an in-canal microphone of the hearing device 50 as described in further detail below with reference to FIG. 2.

The processing unit 135 may be configured to execute a suitable operating system. The operating system may be configured to manage various hardware and software resources of the hearing device 50 such as handling of a wireless communication interface and its protocol. The operating system may schedule computational and control tasks for efficient use of hearing device resources and may further include accounting software for cost allocation, including power consumption, processor time, memory locations, wireless transmissions, and other resources. The operating system may be stored in and retrieved from a non-volatile memory (not shown), e.g. flash memory or EEPROM, of the processing unit 135.

The housing 125 of the hearing device 50 may for example be one of many well-known types from the hearing aid industry like so-called BTE, ITE, ITC, CIC or RIC housings. These types of housings are generally shaped and sized for placement at, or in, the user's ear. The skilled person will understand that the housing 125 may comprise several physically separate sections such as a first housing or section that is arranged behind the user's ear and a second section configured for arrangement in the user's ear canal 130 such as a customized ear plug. The skilled person will appreciate that an acoustic leakage path H2 may exist around, or through, the housing 125 when the housing is mounted in the user's ear canal 130. This acoustic leakage path H2 may be intended or unintended and for example intended by provision of a so-called through-going vent of the housing for the purpose of passive occlusion relief. In both situations the acoustic leakage path H2 transmits noise sound components from an external environment 109 into the user's ear canal volume 65. Further, the body-conducted sound, as schematically represented by reference sign 165, is emitted into the ear canal volume 65 for example caused by the user's own voice. These generally undesirable noise sounds are via the respective transmittal mechanisms mixed with desired sounds or sound components in the user's ear canal volume 65 to form a composite sound pressure as schematically represented by reference sign 155.

A desired or target sound in the user's ear canal volume 65 is represented by a processed audio signal (R*u), supplied at an output of the processing unit 135 multiplied by the transfer function (R) of the receiver 120. The Active Occlusion Cancellation (AOC) arrangement 160 comprises the in-canal microphone 115 and the vibration sensor 110. The AOC arrangement 160 preferably comprises a feedback path that adaptively generates a first compensation signal based on an in-canal audio signal (m) generated by the in-canal microphone 115 in response to the sound e.g. the composite sound pressure, in the user's ear canal volume 65. The AOC arrangement 160 preferably additionally comprises a forward path that adaptively generates a second compensation signal derived from a vibration signal generated by the vibration sensor 110. The vibration sensor 110 is configured for pick-up of mechanical vibration of the user's ear canal tissue 130 where said vibration for example is generated by at least body-conducted sound for example by the user's own speech. The skilled person will appreciate that the vibration sensor 110 is substantially insensitive to acoustic sound like the sound in the user's ear canal volume 65. The first compensation signal and the second compensation signal are subtracted from the processed audio signal (u) to supply the receiver input (y) as discussed in additional detail below. The utilization of at least two distinct compensation signals, the first one that is derived from sound sensed in the ear canal volume 65 and the second one that is derived from mechanical tissue vibration caused by body-conducted sound, represent different estimates of the undesired body-conducted sound in the user's ear canal volume 65. The accuracy of the estimate of the body-conducted sound in the ear canal volume 65 is improved by such utilization of at least two distinct compensation signals for numerous reasons. For example because the vibration signal is not contaminated or polluted with various types of acoustic noise, or infected by the processed target signal, unavoidably transmitted into the user's ear canal volume 65 and picked-up by the in-canal microphone 115 as sound of the in-canal audio signal (m). The improved accuracy of the estimate of the undesired body-conducted sound in the user's ear canal volume 65 leads to improved suppression of the body-conducted sound in the ear canal volume 65 and hence to reduction of the subjective occlusion effect on the user of the hearing device 50.

FIG. 2 shows a block diagram of various embodiments the exemplary hearing device 50. The hearing device 50 comprises the previously discussed components such as the ambient microphone 105, the processing unit 135, the in-canal microphone 115, the vibration sensor 110, the receiver 120, the housing 125, the ambient microphone 105. The acoustic leakage path H2 is also schematically illustrated but the skilled person will appreciate that it may not form part of the hearing device 50, but is a model representation of the transfer function of the leakage path H2. H4 is a transfer function from the vibration source such as the user's vocal chords to the ear canal volume 65.

The processing unit (135) is configured to process the ambient audio signal (x1) in accordance with one or several predetermined signal processing algorithm(s) to generate the processed audio signal (u). One of the predetermined signal processing algorithm(s) may comprise a hearing loss compensator or algorithm to supply a hearing loss compensated audio signal as a component of the processed audio signal (u) for compensation of the user's hearing loss. The hearing loss compensator may comprise dynamic range compression for example loss of dynamic range as a function of frequency.

The hearing device 50 comprises the previously discussed feedback path that comprises the first filter 205 which is configured to supply the first compensation signal 219 to a first input of a first subtractor 150 for cancelling at least the body-conducted sound in the user's ear canal volume 65 based on the in-canal audio signal (m). The feedback path comprises a closed feedback loop comprising the transfer function (R) from the receiver input (y) to the in-canal audio signal (m), second subtractor 217, a first filter 205, and the first subtractor 150 for which its output is applied to the input (y) of the receiver to close the feedback loop. The skilled person will understand that in practice, the first filter 205 may additionally be operative to suppress other types of unwanted sound in the user's ear canal volume 65 via the feedback path. These other types of unwanted sound may comprise the previously discussed noise sound transmitted into the user's ear canal volume 65 via the acoustic leakage path H2. The efficiency of this suppression of the other types of unwanted sound in the user's ear canal volume 65 may depend on spectral and temporal characteristics of the unwanted sound.

A second, and optional, filter 203 is configured to model a transfer function (R) from the receiver input (y) to the in-canal audio signal (m) of the in-canal microphone 115. The second filter 203 is thus configured to model the individual transfer functions of the receiver 120, the sound path comprising the ear canal volume 65 between receiver output and input to the in-canal microphone (115) and the in-canal microphone 115. The hearing device 50 comprises a first feedforward path that comprises a third filter 211 which configured to supply a second compensation signal 213 to a second input of the first subtractor 150, for example via an optional further adder 207, for cancelling, or at least suppressing a level of, at least the body-conducted sound in the user's ear canal volume 65 based on the vibration signal x2. The first feedforward path is arranged outside the closed feedback loop of the feedback path. The output of the first subtractor 150 is applied as the receiver input (y) as mentioned above such that the receiver responds by emitting a corresponding output sound or output sound pressure into the user's ear canal volume 65.

Some embodiments of the hearing device 50 comprises a fourth adaptive filter 209 configured to supply a third compensation signal 210 that is based on the ambient microphone signal x1 and operative to further improve the suppression of the other noise sounds, than the body-conducted sound 165, within the user's ear canal volume 65. As mentioned above the other types of noise sound may be transmitted from the external environment via the acoustic leakage path H2 into the user's ear canal volume 65. The other types of noise sound may comprise external noise such as noise arriving acoustically at the ambient microphone 105 from an external source. The external noise may comprise traffic noise and/or so-called cocktail party noise that comprises a mixture of speech from multiple persons in the vicinity of the user of the hearing device.

The fourth adaptive filter 209 forms part of a second feedforward path of the hearing device 50. The third compensation signal 210 is preferably applied to a third input of the first subtractor 150.

An output of the second subtractor 217 generates an error signal (v′) as an input of the first filter 205 as discussed above. The second subtractor 217 accordingly supplies the error signal (v′) by subtracting an output 221 of the second filter 203 from the in-canal audio signal (m). The skilled person will understand that the processing unit 135 may be configured to carry out adaptation of a plurality of filter coefficients of the first filter 205 of the feedback path as discussed in additional detail below. The processing unit 135 may be configured to carry out adaptation of a plurality of filter coefficients of the second filter 203 and likewise carry out adaptation of a plurality of filter coefficients of the third filter 211 of the feedforward path as discussed in additional detail below. The processing unit 135 may be configured to carry out adaptation of a plurality of filter coefficients of the fourth filter 209 as discussed in additional detail below. The skilled person will understand that the processing unit 135 may be configured to in parallel or simultaneously carry out, during normal operation of the hearing device 50, the respective adaptations of at least the first filter 205 and third filter 211 to obtain the first and second estimates of the body-conducted sound in the user's ear canal volume 65.

The processing unit 135 may be configured to carry out the respective adaptations or adjustments of the first filter 205, the second filter 203 and the third adaptive filter 211 to meet a particular target of the error signal (v′) such as minimizing the energy or power of the error signal (v′). The minimization of the energy or power of the error signal (v′), or other targets of the error signal (v′), may for example be carried out for a predetermined audio frequency range of interest, such as for occlusion suppression, such as between 20 Hz and 2 kHz or between 50 Hz and 400 Hz or below 1 kHz for example below 500 Hz. Adaptations of each of the first adaptive filter 205, the second filter 203 and the third adaptive filter 211 and the fourth filter 209 may be carried out by the processing unit 135 using well-known optimization algorithms, without being restricted to, a least mean square (LMS) algorithm, a normalized least mean square (NLMS) algorithm, a recursive least squares (RLS) algorithm etc.

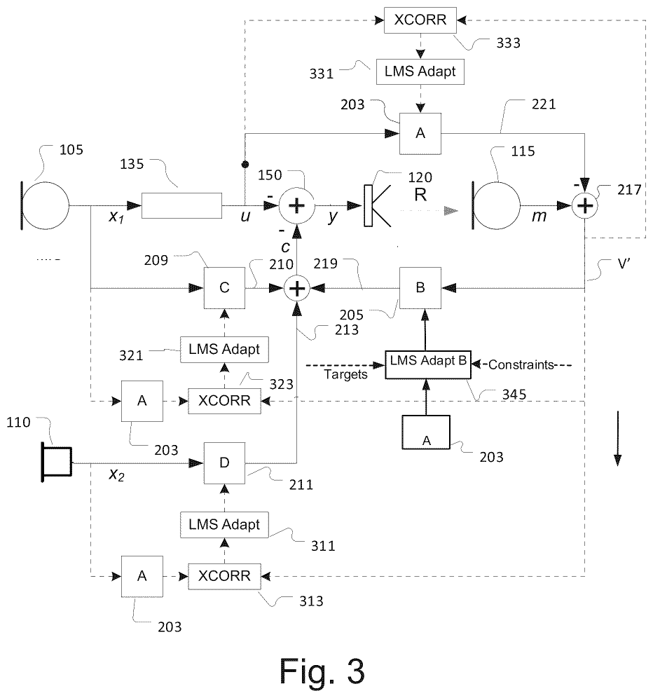

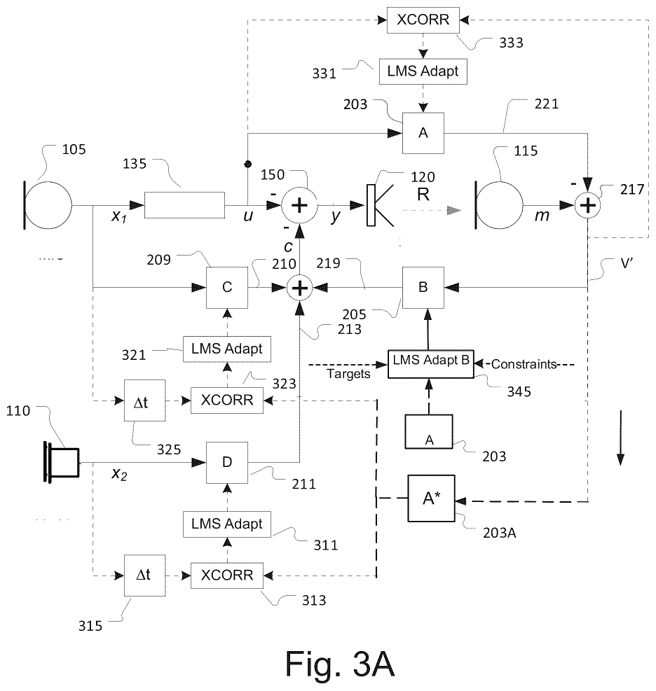

FIG. 3 shows schematically a first embodiment of the exemplary hearing device 50, in particular the respective computational models of the first adaptive filter 205, the second filter 203 where operating adaptively during normal operation, the third adaptive filter 211 and the optional fourth filter 209.

The skilled person will appreciate that the error signal (v′) can be approximated by equation (1):

$$\frac{( ( R - A ) G + \frac{H 2}{H 1} - CR ) {x}_{1} + ( \frac{H 4}{H 3} - DR ) {x}_{2}}{1 + BR} \qquad ( 1 )$$

wherein:
A: is a transfer function of the second filter (203);
B: is a transfer function of the first adaptive filter (205);
C: is a transfer function of the fourth filter (209);
D: is a transfer function of the third filter (211);
G: is the transfer function of the processing unit (135);
R: is the transfer function from the receiver input (y) to the in-canal audio signal (m);
H1: is a transfer function from the ambient sound to the ambient audio signal (x1);
H2: is a transfer function from the ambient sound to the ear canal volume (65);
H3: is a transfer function from a source of the vibration signal, e.g. the user's vocal
cords, to the vibration sensor (110); and
H4: is a transfer function from the vibration source to the ear canal volume (65).

The skilled person will appreciate that the in-canal audio signal (m) can be approximated by equation (2):

$$m = \frac{( ( 1 + BA ) GR + \frac{{H}_{2}}{{H}_{1}} - CR ) {x}_{1} + ( \frac{{H}_{4}}{{H}_{3}} - DR ) {x}_{2}}{1 + BR} \qquad ( 2 )$$

The skilled person will appreciate that the benefit of the active occlusion suppression circuit against the external noise, i.e. noise arriving acoustically at the ambient microphone 105 from an external source, condition x2=0 and G=0, can be derived from equations (1) and (2) as expressed by equation (3) below:

$$\to \frac{1 - CRH 1 / H 2}{1 + BR} \qquad ( 3 )$$

The skilled person will appreciate that the benefit of the active occlusion suppression circuit against internal noise such as the body-conducted sound in the user's ear canal volume (65,) e.g. generated by the user's own voice), corresponding to the condition x1=0, can be derived from equations (1) and (2) as expressed by equation (4) below:

$$\frac{1 - DRH 3 / H 4}{1 + BR} \qquad ( 4 )$$

In case the active occlusion suppression circuit is disabled, i.e. each of the respective filter transfer functions A, B, D and C is =0, then the transfer function to the in-canal audio signal (m) reduces to:

$${m}_{off} = ( GR + \frac{H 2}{H 1} ) {x}_{1} + ( \frac{H 4}{H 3} ) {x}_{2} \qquad ( 5 )$$

Therefore, the benefit of the active occlusion suppression circuit against the external noise according to equation (3) above is computed by setting x2=0 and divide the in-canal audio signal (m), as expressed by equation (2), with m_{off} according to equation (5). The ratio resulting from the latter division represents the amount, e.g. expressed in decibels (dB) or as a natural number as function of frequency, that the external noise is attenuated or suppressed. In other words if the ratio is markedly smaller than 1.0, e.g. less than 0.3 or less than 0.1 at a particular audio frequency of interest, then the occlusion suppression at that audio frequency provides a beneficial reduction of the external noise from about 10 dB to 20 dB. On the other hand if the ratio is close to 1.0, or even worse larger than 1.0, the active occlusion suppression circuit provides no noticeable suppression of the external noise or even worse increases the level or amount of the external noise.

The benefit of the active occlusion suppression circuit against the internal noise, which comprises the body-conducted sound in the user's ear canal volume, according to equation (4) above is computed by setting x1=0 and divide the in-canal audio signal (m), as expressed by equation (2), with m_{off} according to equation (5). The ratio of the latter division represents, e.g. expressed in decibels (dB) or as a natural number as function of frequency, the amount the internal noise is attenuated or suppressed.

Similarly to the suppression of the external noise discussed above, if the ratio associated with the internal noise is markedly smaller than 1.0, e.g. less than 0.3 or less than 0.1 at a particular audio frequency of interest or audio frequency range of interest, then the occlusion suppression at the frequency or frequency range provides a beneficial reduction of the internal noise from about 10 dB to 20 dB. On the other hand if the ratio is close to 1.0, or even worse larger than 1.0, the active occlusion suppression circuit provides no noticeable occlusion suppression or even amplifies the occlusion effect.

The processing unit 135 may be configured to adjust the transfer function of the second filter 203 to minimize the error signal (v′). This adjustment of the transfer function of the second filter 203, irrespective whether carried out at initialization of the active occlusion circuit or adaptively during normal operation of the hearing device, provides a good estimate of R. The function of the second filter 203 is ideally to eliminate, or at least suppress in the canal audio signal (m) the desired output signal (R*u) supplied by the receiver 120 from the feedback path. In this way, the subtraction performed by the second subtractor 217 prevents the desired signal, which is the processed audio signal (u), from being suppressed by the feedback path. The minimization of the error signal (v′) carried out by the second filter 203 comprises a third cross-correlator 333 that carries out cross-correlation of the error signal (v′) and the processed audio signal (u) to calculate a third gradient direction. The third gradient direction is applied by the processing unit 135 to a third optimization algorithm such as normalized least mean square (NLMS), recursive least squares (RLS) etc. The adaptation function 331 may be configured to repeatedly compute and update filter coefficients of the second adaptive filter 203 during normal use of the hearing device.

The processing unit 135 may further minimize the error signal (v′) by adapting the transfer function of the first adaptive filter 205 to maximize a real part of the loop response denominator (1+BR) for computational purposed replaced by (1+B*A) during normal operation of the hearing device. In other words, the computed transfer function of the second filter 203 may be utilized as an estimate of the transfer function R and therefore inputted to the exemplary LMS Adapt B function 345. The transfer function of the second filter 203 is already available to, or stored in, the processing unit 135 due to the above-mentioned operations of the third cross-correlator 333 and LMS adaptation 331. The minimization of the error signal (v′) may comprise updating filter coefficients of the first adaptive filter 205 by LMS (least mean square) adaptation 345 or using other suitable optimization techniques or algorithms such as normalized least mean square (NLMS), recursive least squares (RLS), etc.

The processing unit 135 may for example be configured to minimize a norm of the error signal (v′) such as a 1-norm or a 2-norm by the exemplary LMS Adapt B function 345 while satisfying constraints on gain and stability of the closed loop response of the feedback path. In an alternative embodiment, the first adaptive filter 205 is not directly controlled by the error signal (v′) but instead indirectly controlled by the error signal (v′) based on changes of the transfer function of the second filter 203. The latter embodiment leads to a slower adaptation of the first adaptive filter 205 which slower adaptation serves to suppress effects of momentary changes of the in-canal audio signal (m) in a desirable manner.

The processing unit 135 may be configured to maximize the real part of the loop response denominator (1+B*R) over a certain frequency range of particular importance for occlusion suppression for example between 20 Hz and 1 kHz such as between 50 Hz and 400 Hz. Stability of the closed loop response of the feedback path is guaranteed when the Nyquist contour, i.e. a curve spanned by the complex values from all frequencies in the z-plane, does not encircle zero. That objective may be reached by maximizing the real part of (1+B*R) to obtain large positive values thereof and hence avoid encircling the origin of the z-plane.

The transfer function of the first adaptive filter (205) may be adapted to optimize the closed loop response of the feedback path exploiting a set of constraints and targets. The targets may specify a desired amount of cancellation at desired frequencies and the constraints limit undesired side effects. Constraints are defined for the following aspects:
1. As mentioned above, stability is guaranteed when the Nyquist contour does not encircle zero or origin. In principle, determining Nyquist stability may require a procedure for counting encirclements of the origin (clockwise minus counter-clockwise), which procedure may be computationally demanding. However, the criterion can be simplified by setting a positive lower limit for the real parts of the complex values because if the contour only uses positive real values it simply cannot encircle the origin.
2. Max peaking of the closed loop response of the feedback path sets an upper limit for the expected closed loop gain.
3. Max loop gain of the closed loop transfer function of the feedback path sets an upper limit for the expected open loop gain.
4. Max gain of the first adaptive filter 205 sets an upper limit for the gain |B| of the filter 205.

When the set of constraints are fulfilled, the selected adaptation algorithm utilized by the processing unit 135 adapts towards the targets to improve cancellation performance, i.e. constraints are preferably satisfied first. The skilled person will appreciate that normally all constraints can be met simply by reducing the loop gain. The loop gain may be reduced during normal operation of the hearing device using a scalar gain control so that for reasonable settings there is always a solution that satisfies all constraints.

The processing unit 135 is further configured to adapt the third filter 211 of the feedforward path to minimize the error signal (v′). The adaptation of the transfer function of the third filter 211 includes filtering of the vibration signal x2 by the second filter 203. A copy or instance of the second filter 203 is arranged in series with a first input of a first cross-correlator 313 which is associated with the third adaptive filter 211. The skilled person will understand that first input of the first cross-correlator 313 represents the vibration signal (x2) filtered by the transfer function A of the second filter 203. The first cross-correlator 313 is configured to cross-correlate the error signal (v′) with a copy of the output of the second filter 203 to calculate a first gradient direction. The first gradient direction is applied by the processing unit 135 to a first optimization algorithm such as LMS or NLMS and schematically indicated by an adaptation function 311. The adaptation function 311 may be configured to repeatedly compute and update filter coefficients of the third adaptive filter 211.

The processing unit 135 is further configured to adapt the transfer function of the fourth adaptive filter 209 of the second feedforward path to minimize the error signal (v′). A copy of the second filter 203 is arranged between the ambient microphone signal (x1) and a first input of a second cross-correlator 323 which is associated with the fourth adaptive filter 209. The cross-correlator 323 is configured to cross-correlate the error signal (v′) with a copy of the output of the second filter 203 to calculate a second gradient direction. The second gradient direction is applied by the processing unit 135 to a second optimization algorithm such as LMS or NLMS and schematically indicated by an adaptation function 321. The adaptation function 321 may be configured to repeatedly compute and update filter coefficients of the fourth adaptive filter 209.

FIG. 3A shows schematically a second embodiment of the exemplary hearing device 50, in particular the respective computational models of the first filter 205, the second filter 203 when operating adaptively during normal operation, the third adaptive filter 211 and the optional fourth filter 209. Each feature of the second embodiment on FIG. 3A is provided with the same reference numeral as that of the first embodiment of FIG. 3 discussed above unless otherwise stated.

The second embodiment of the exemplary hearing device 50 may reduce the computational load of the processing unit 135 because multiple instances of the second filter 203 are eliminated. More specifically, the second filter 203 is moved to the opposite side of the first cross-correlator 313 such that the error signal (v′) is processed by a time reversed instance (A*) 203A of the second filter 203 before being applied to a second input of the first cross-correlator 313. The second filter 203 is similarly moved to the opposite side of the cross-correlator 323 such that the error signal (v′) is processed by a time reversed instance (A*) 203A of the second filter 203 before being applied to the second input of the second cross-correlator 323. In other words the computation load imparted by adaptation of the coefficients of the second filter 203 can be shared between the third adaptive filter 211 and fourth adaptive filter 209. A first time delay block 315 is inserted in front of the first input of the first cross-correlator 313 and a second time delay block 325 is inserted in front of the first input of the second cross-correlator 323. The time delay of each of the first and second time delay blocks corresponds to the time delay of AA* for example expressed as an integer number of samples. The skilled person will appreciate that the transfer function (A) of the second filter 203 is already available to the processing unit 135 via the adaptation of the filter coefficients of the first adaptive filter 205. The processing of the error signal (v′) in the time reversed instance (A*) 203A may be carried out in the time domain by convolution or in the frequency domain using multiplication.

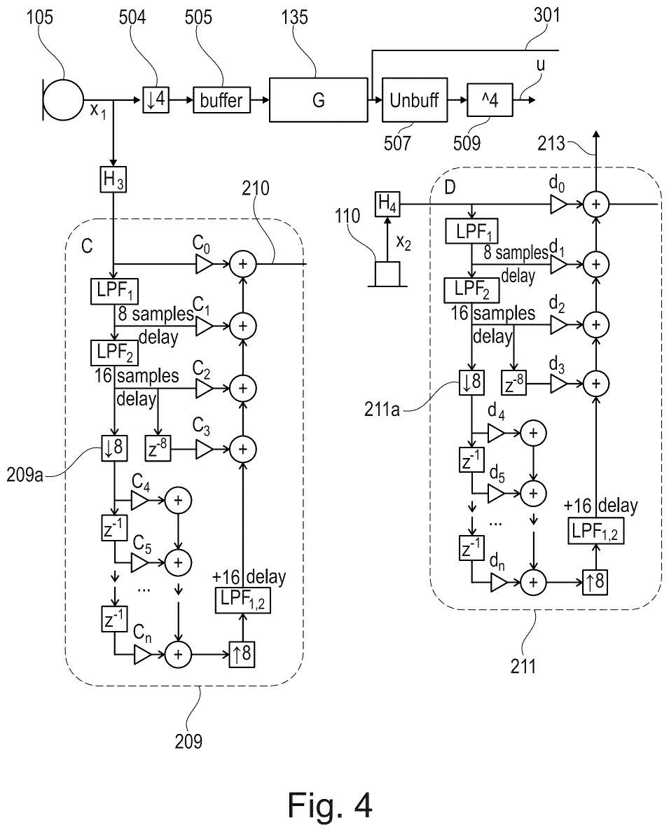

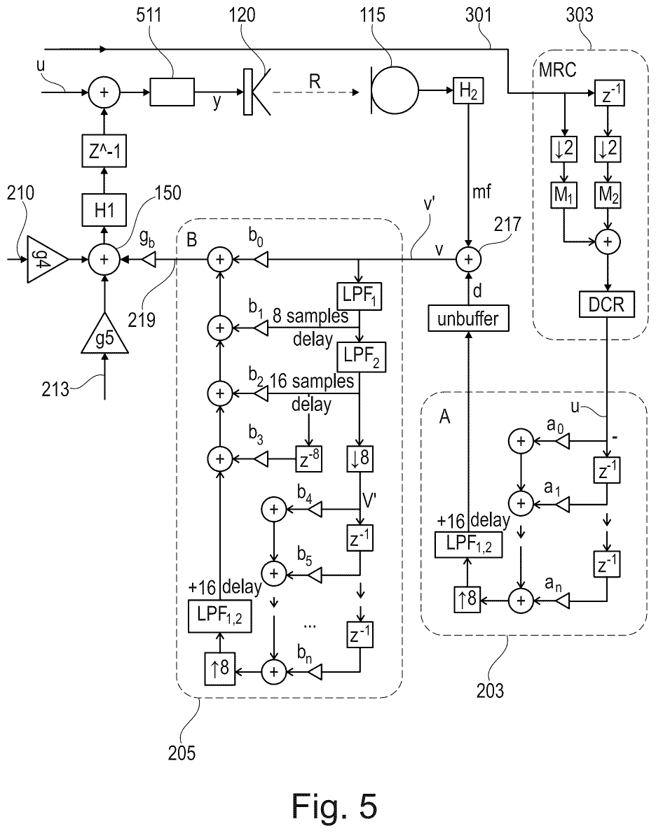

FIG. 4 and FIG. 5 are jointly a block diagram of certain embodiments of the exemplary hearing device 50 such as the first and second embodiments of the hearing device discussed above. The block diagram shows in schematic form respective topologies of preferred embodiments of the first adaptive filter 205, the second filter 203, the third adaptive filter 211 and the optional fourth adaptive filter 209. The skilled person will appreciate that the first adaptive filter 205, the second filter 203, the third adaptive filter 211 and the optional fourth adaptive filter 209 as illustrated on FIGS. 2 and 3 may be identical to the corresponding filter illustrated on FIGS. 4 and 5. The first adaptive filter 205 and third adaptive filter 211, and optionally the fourth adaptive filter 209, may possess similar topologies and preferably comprises a multi-rate filter topology or design to obtain low time delay. To obtain the low time delay each of the first adaptive filter 205, third adaptive filter 211 and fourth adaptive filter 209 may be configured to process their respective input signals on a sample-by-sample basis. The low time delay through each of the filters is critical for the particular cancellation performance of the first adaptive filter 205, third adaptive filter 211 and fourth adaptive filter 209. Leading filter taps, i.e. the respective taps before down-sampling within each filter, such as the filter coefficient b₀ of the first adaptive filter 205, the filter coefficient do of the third adaptive filter 211 and the filter coefficient co of the fourth adaptive filter 209 operate at full sample rate. To minimize processing delay, the full sample rate should typically be higher than the sample rate typically used for normal hearing device applications. Exemplary full sample rates may be above 80 kHz, but even higher full sample rates such as at or above 96 KHz, 192 KHz and 250 kHz could be advantageous.

The subsequent filter stages are fed by respective down-samplers 209a, 211a, that lower sample rates by a predetermined factor e.g. by 4, 8 or 16 for example sample rates between 8 and 16 kHz such as about 10 kHz. This down-sampling reduces complexity of the adaptive filter in question and reduces its power consumption. The respective lowpass filters LPF₁. LPF₂ are preferably moving average filters for example with low fixed-point complexity such that uniform time delay between filter taps is obtained similarly to FIR filters. The group delay between filter taps may be constant (d samples) as a function of frequency as for an ordinary FIR filter. The magnitude responses of the leading filter taps with respective filter coefficients b₀, d₀ and C₀ are different for high frequencies. The respective lowpass filters like H₃, in front of the input of the fourth adaptive filter 209, H₄ in front of the input of the third adaptive filter 211 may provide anti-aliasing protection of the respective adaptive filters 209, 211.

The lowpass filters H₃ and H₄ provide additional beneficial effects such as control frequency response characteristics of the respective adaptive filters 209, 211 at high frequencies, e.g. above 5 kHz, and/or low frequencies e.g. below 50 Hz or below 20 Hz. For the high frequencies the lowpass filtering reduces frequency response inaccuracy caused by differences between the respective leading taps of the adaptive filters 209, 211 which reduce the computational load caused by updating or adapting respective filter coefficients of the adaptive filters 209, 211. Furthermore, the lowpass filters H₃ and H₄ may comprise respective highpass filters configured to provide still further beneficial effects such as removal of DC and prevent subsonic signal from saturating the adaptive filters 209, 211.

With respect to properties of the third adaptive filter 211, that processes the vibration signal x2, experimental results and MATLAB simulations reveal that the number of filter taps and corresponding filter coefficients d₀, d₁, d₂, . . . , d_{N} may be larger than 16 e.g. larger than 31 for example larger than 63. to achieve good cancellation performance over the previously discussed frequency range of interest for occlusion suppression. The third adaptive filter 211 may be designed with a group delay at 1 KHz between 10 and 500 microseconds.

With respect to properties of the fourth adaptive filter 209, that processes the ambient microphone signal x1 to suppress external acoustic noise, experimental results and MATLAB simulations reveal that the number of filter taps and corresponding filter coefficients (C₀, C₁, C₂, . . . , CN) may be larger than 16, e.g. larger than 31 for example larger than 63 to achieve good cancellation performance. The third adaptive filter 211 may be designed with a group delay at 1 KHz between 10 and 100 microseconds.

The second filter 203 is preferably configured to process its input 301, which is the processed audio signal (u), in blocks of samples for example sample blocks with a size between 4 and 64 samples. The processing unit 135 may comprise a buffer 505 (FIG. 4) which may be arranged in-front of the processing unit 135, for example in series with optional down-sampler 504, or the buffer 505 may in practice form an integral part of the processing unit 135. The buffer 505 converts the sample-by-sample format of the ambient audio signal (x1) into corresponding blocks of samples of the above-mentioned size and applies these blocks of samples to the input of the processing unit 135. The processed audio signal (u) outputted by the processing unit 135 may accordingly be in formatted or structured as blocks of samples and inputted to the second filter 203 via signal path 301 for the processing of the latter. As schematically the processing unit 135 may comprise a Matched Rate Conversion (MRC) block 303, which matches the sound path through interpolation (up to 4 times of lowpass filter H₂) and decimation functions LPF1 and LPF2 to down sample directly from e.g. 20.8 kHz to 10.4 kHz. The Matched Rate Conversion block 303 is preferably configured to provide accurate time alignment with the acoustic path from the processed audio signal (u) to the audio signal mf (FIG. 5). Consequently, when the transfer function A of the second filter (203) matches the transfer function R, from the receiver input (y) to the in-canal audio signal (m), the desired output sound (Ru) is largely eliminated from the feedback path. Consequently, cross-correlations between (u′) and (v′) should therefore preferably be minimal. The Matched Rate Conversion block 303 is preferably configured such that the relative time alignment between processed audio signal (u) and the error signal (v) is maintained in their down-sampled versions (u′), (v′) which are extracted from respective buffers of the second filter 203 and the first adaptive filter 205.

The skilled person will understand that the block-based processing of samples by the processing unit 135 and the second filter 203 is advantageous because block-based processing of audio signals is generally computationally efficient with low power consumption. The block-based processing of the processing unit 135 and the second filter 203 may comprise various forward and backward frequency-domain transforms like FFT/iFFT etc. Where the processing unit 135 is based on block-based processing, the processing unit 135 preferably further comprises a so-called un-buffer circuit 507 (FIG. 4) that is configured to convert the processed audio signal (u) from the blocks of samples format to the sample-by-sample format and apply the latter signal format to one or more of the first adaptive filter 205, third adaptive filter 211 and fourth adaptive filter 209. The processing by the un-buffer circuit 507 is beneficial to obtain the previously discussed low time delay processing in the one or more of the first adaptive filter 205, third adaptive filter 211 and fourth adaptive filter 209. The processing unit 135 may comprise an up-sampler 509 in series with the output of the un-buffer circuit 507 to increase the sampling frequency of the processed audio signal (u) with an integer number like 4, 8 or 16 etc.

As used in this specification, the term “processing unit” is not limited to the item 135 shown in the figure, and may alternatively be used to refer to any processing component or combination of processing components described herein in association with the hearing device. For example, in some cases, the term “processing unit” refer to filter(s) (e.g., first filter, second filter, third filter, fourth filter, or any combination of the foregoing), one or more subtractors, item 135, or any combination of the foregoing.

Exemplary methods and hearing devices according to the disclosure are set out in the following items:

### Items:

Item 1. A hearing device comprising:
an ambient microphone (105) configured for pick-up of ambient sound at a user's ear and respond by generating an ambient audio signal (x1),
an in-canal microphone (115) configured for pick-up of sound in an ear canal volume (65) in front the user's tympanic membrane (55) comprising body conducted sound and respond by generating an in-canal audio signal (m),
a vibration sensor (110) configured for pick-up of mechanical vibration generated by at least the body-conducted sound of the user and respond by generating a vibration signal (x2),
a processing unit (135) configured to process the ambient audio signal (x1) in accordance with a predetermined signal processing algorithm to generate a processed audio signal (u),
a receiver (120) configured for emission of output sound into the user's ear canal volume (65) in response to a receiver input (y); and
a feedback path comprising a first filter (205) configured to supply at first compensation signal (219) for cancelling at least the body-conducted sound in the user's ear canal volume (65) based on the in-canal audio signal (m),
a second filter (203) configured to model a transfer function (R) from the receiver input (y) to the in-canal audio signal (m) of the in-canal microphone (115),
a feedforward path comprising a third filter (211) configured to supply a second compensation signal (213) for cancelling at least the body-conducted sound in the user's ear canal volume (65) based on the vibration signal (x2).

Item 2. A hearing device (50) according to Item 1, wherein the processing unit comprises:
a fourth filter (209) configured to supply a third compensation signal (210) for cancelling noise sound transmitted into the user's ear canal volume (65), such as via acoustic leakage around a housing of the hearing device or via the ambient audio signal (x1), based on the ambient microphone signal (x1).

Item 3. A hearing device according to Item 1 or 2, wherein the processing unit is configured to:
subtract the first compensation signal (219) from the processed audio signal (u) by a first subtractor (150),
subtract the second compensation signal (213) from the processed audio signal (u) by the first subtractor (150); and
apply an output of the first subtractor (150) to the receiver input.

Item 4. A hearing device according to Item 3, comprising a second subtractor (217) comprising an output configured to generate an error signal (v′) by subtracting: an output (221) of the second filter (203) from the in-canal audio signal (m); and apply the error signal (v′) to an input of the first filter (205).

Item 5. A hearing device according to any of Items 2-4, wherein the first subtractor (150) is configured to subtract the third compensation signal (210) from the processed audio signal (u).

Item 6. A hearing device according to Item 4 or 5, wherein the processing unit (135) is configured to minimize energy or power of the error signal (v′) over a predetermined frequency range such as above 50 Hz or between 20 Hz and 1 kHz for example between 100 Hz and 400 Hz.

Item 7. A hearing device according to Item 6, wherein the processing unit (135) is configured to minimize the energy or power of the error signal (v′) by:
adapt or adjust a transfer function of the first filter (205) to maximize a real part of (1+B*R),
adapt or adjust a transfer function of the second filter (203) to minimize the error signal (v′),
adapt or adjust a transfer function of the third filter (211) to minimize the error signal (v′); and optionally
adapt or adjust a transfer function of the fourth filter (209) to minimize the error signal (v′), wherein
   B: is a transfer function of the first filter (205);
   R: is a transfer function from the receiver input (y) to the in-canal audio signal (m).

Item 8. A hearing device according to Item 7, wherein the processing unit (135) is configured to minimize the energy or power of the error signal (v′) by minimizing a norm of the error signal (v′) such as a 1-norm or a 2-norm; wherein the error signal (v′) is represented according to equation (1)

$$\frac{( ( R - A ) G + \frac{H 2}{H 1} - CR ) {x}_{1} + ( \frac{H 4}{H 3} - DR ) {x}_{2}}{1 + BR}$$

wherein:
A: is a transfer function of the second filter (203);
B: is the transfer function of the first filter (205);
C: is a transfer function of the third filter (209);
D: is a transfer function of the fourth filter (211);
G: is the transfer function of the processing unit (135):
R: is the transfer function from the receiver input to the in-canal audio signal (m);
H₁: is a transfer function from the ambient sound to the ambient audio signal (x1);
H₂: is a transfer function from the ambient sound to the ear canal microphone signal (m);
H₃: is a transfer function from a source of the vibration signal, e.g. the user's vocal cords, to the vibration sensor signal (x2);
H₄: is a transfer function from the vibration source to the ear canal microphone (m)

Item 9. A hearing device according to any of the preceding Items, wherein the digital signal processing (DSP) is configured to adapt the transfer function of the first filter (205) and adapt the transfer function of the third filter (211) during normal operation of the hearing device.

Item 10. A hearing device according any of Items 7-9, wherein the processing unit is configured to:
adapting the transfer function of the second filter (203) by cross-correlating the processed audio signal (u) and the error signal (v′) to calculate a first gradient direction,
apply the first gradient direction in a first optimization algorithm such as LMS or NLMS; and
adapting the transfer function of the third filter (211) by filtering the vibration signal (x2) with the transfer function of the second adaptive filter (203) to provide a processed output signal,
cross-correlating the processed output signal and the error signal (v′) to calculate a second gradient direction; and
apply the second gradient direction in a second optimization algorithm such as LMS or NLMS.

Item 11. A hearing device according to any of the preceding Items, comprising a housing; said housing (50) comprising:
an exteriorly oriented surface comprising a sound inlet (227) of the ambient microphone (105),
an interiorly oriented tip facing the user's ear canal volume (65) and supporting a sound outlet (223) of the receiver (120),
a side surface configured to make a vibration sensitive section of the vibration sensor (110) physically contact the user's ear canal during normal use of the hearing device.

Item 12. A method of suppressing at least body-conducted sound in an ear canal volume (65) of a user of a hearing device (50), comprising:
pick-up of ambient sound at the user's ear to generate a corresponding ambient audio signal (x1),
process the ambient audio signal (x1) in accordance with a predetermined signal processing algorithm to generate a processed audio signal (u),
pick-up sound in the ear canal volume (65) by an in-canal microphone (115) to generate a corresponding in-canal audio signal (m), wherein said sound comprises the at least body-conducted sound,
pick-up, by vibration sensor (110), mechanical vibration of ear canal tissue of the user and generate a corresponding vibration signal (x2),
emit output sound into the user's ear canal volume (65) by a receiver (120) in response to a receiver input (y),
cancel at least the body-conducted sound in the user's ear canal volume (65) by a first compensation signal (219) generated by a first filter (205) of a feedback path based on the in-canal audio signal (m),
adjusting or adapting a second filter (203) to model a transfer function (R) from the receiver input (y) to the in-canal audio signal (m) of the in-canal microphone (115),
cancel at least the body-conducted sound in the user's ear canal volume (65) by a second compensation signal (213) generated by a third filter (211) of a feedforward signal path based on the vibration signal (x2).

Item 13. A method of suppressing at least body-conducted sound in an ear canal volume (65) according to Item 12, comprising generation of the receiver input (y) by:
subtract the first compensation signal (219) from the processed audio signal (u),
subtract the second compensation signal (213) from the processed audio signal (u).

Item 14. A method of suppressing at least body-conducted sound in an ear canal volume (65) according to Item 12 or 13, comprising adapting a plurality of filter coefficients of the third filter (211) and adapting a plurality of filter coefficients of the first filter (205) during initialization of the hearing device and/or normal operation of the hearing device.

Item 15. A method of suppressing at least body-conducted sound in an ear canal volume (65) according to any of Items 12-14, comprising:
place the hearing device (50) in normal operation which comprises processing of the ambient audio signal (x1) and emission of the corresponding receiver output sound when the hearing device is mounted in or at the user's ear;
   simultaneously or parallelly adapt the respective transfer functions of the first filter (205) and the third filter (211) and optionally adapt the transfer function of the fourth filter (209).

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

1. A hearing device comprising:
an ambient microphone configured to detect ambient sound and to generate an ambient audio signal based on the detected ambient sound;
an in-canal microphone configured to detect sound in an ear canal of a user, and to generate an in-canal audio signal, wherein the sound in the ear canal comprises body-conducted sound;
a vibration sensor configured to sense mechanical vibration attributable to at least the body-conducted sound, and to generate a vibration signal;
a processing unit configured to process the ambient audio signal in accordance with a signal processing algorithm, wherein the processing unit is also configured to generate a processed audio signal;
a receiver configured to provide output sound into the ear canal based on a receiver input;
a first filter at a feedback path, wherein the first filter is configured to supply a first compensation signal based on the in-canal audio signal;
a second filter configured to model a transfer function associated with the receiver input and the in-canal audio signal; and
a third filter at a feedforward path, wherein the third filter is configured to supply a second compensation signal based on the vibration signal.

2. The hearing device according to claim 1, further comprising a fourth filter configured to supply a third compensation signal for cancelling noise sound transmitted into the ear canal of the user, wherein the third compensation signal is based on the ambient audio signal.

3. The hearing device according to claim 1, wherein the processing unit comprises a first subtractor configured to subtract the first compensation signal from the processed audio signal, and to subtract the second compensation signal from the processed audio signal; and
wherein the processing unit is configured to apply an output of the first subtractor to the receiver input.

4. The hearing device according to claim 3, wherein the processing unit comprises a second subtractor configured to generate an error signal by subtracting an output of the second filter from the in-canal audio signal; and
wherein the processing unit is configured to apply the error signal to an input of the first filter.

5. The hearing device according to claim 4, wherein the processing unit is configured to minimize energy or power of the error signal over a predetermined frequency range.

6. The hearing device according to claim 5, wherein the predetermined frequency range is above 50 Hz, between 20 Hz and 1 kHz, or between 100 Hz and 400 Hz.

7. The hearing device according to claim 4, wherein the processing unit is configured to minimize the energy or power of the error signal by:
adapting or adjusting a first transfer function of the first filter to maximize a real part of (1+B*R),
adapting or adjusting a second transfer function of the second filter,
adapting or adjusting a third transfer function of the third filter,
or any combination of two or more of the foregoing;
wherein B is the first transfer function of the first filter, and R is the transfer function associated with the receiver input and the in-canal audio signal.

8. The hearing device according to claim 4, wherein the processing unit is configured to minimize the energy or power of the error signal by minimizing a norm of the error signal.

9. The hearing device according to claim 4, wherein the error signal is represented according to equation:
$$\frac{( ( R - A ) G + \frac{H 2}{H 1} - CR ) {x}_{1} + ( \frac{H 4}{H 3} - DR ) {x}_{2}}{1 + BR}$$
wherein:
A: is a transfer function of the second filter;
B: is a transfer function of the first filter;
C: is a transfer function of the third filter;
D: is a transfer function of a fourth filter;
G: is a transfer function of the processing unit:
R: is the transfer function associated with the receiver input and the in-canal audio signal, and is a transfer function from the receiver input to the in-canal audio signal;
H1: is a transfer function from the ambient sound to the ambient audio signal;
H2: is a transfer function from the ambient sound to the in-canal audio signal;
H3: is a transfer function from a source of the mechanical vibration to the vibration signal from the vibration sensor; and
H4: is a transfer function from the source to the in-canal microphone.

10. The hearing device according to claim 1, wherein the processing unit comprises a fourth filter configured to supply a third compensation signal based on the ambient audio signal; and
wherein the processing unit comprises a first subtractor configured to subtract the third compensation signal from the processed audio signal.

11. The hearing device according to claim 1, wherein the hearing device is configured to adapt a transfer function of the first filter and adapt a transfer function of the third filter during normal operation of the hearing device.

12. The hearing device according to claim 4, wherein the processing unit is configured to:
cross-correlate the processed audio signal and the error signal to calculate a first gradient direction;
apply the first gradient direction in a first algorithm;
filter the vibration signal to generate a processed output signal;
cross-correlate the processed output signal and the error signal to calculate a second gradient direction; and
apply the second gradient direction in a second algorithm.

13. The hearing device according to claim 1, further comprising a housing, wherein the housing comprises:
an exteriorly oriented surface comprising a sound inlet for the ambient microphone;
an interiorly oriented surface configured to face the ear canal of the user; and
a side surface configured to cause a vibration sensitive section of the vibration sensor to physically contact the ear canal of the user during normal use of the hearing device.

14. The hearing device according to claim 1 wherein the ambient microphone is configured to detect the ambient sound at an ear of the user.

15. The hearing device according to claim 1 wherein the first compensation signal is configured to cancel at least the body-conducted sound.

16. The hearing device according to claim 1 wherein the second filter is configured to model the transfer function from the receiver input to the in-canal audio signal.

17. The hearing device according to claim 1 wherein the second compensation signal is configured to cancel at least the body-conducted sound.

18. The hearing device according to claim 1, wherein the first compensation signal and/or the second compensation signal is for cancelling at least the body-conducted sound.

19. The hearing device according to claim 1, wherein the processing unit comprises the first filter, the second filter, the second filter, or any combination of the foregoing.

20. A method performed by a hearing device, the method comprising:
detecting ambient sound;
generating an ambient audio signal based on the detected ambient sound;
processing the ambient audio signal in accordance with a signal processing algorithm to generate a processed audio signal;
detecting sound in an ear canal of a user by an in-canal microphone of the hearing device;
generating an in-canal audio signal based on the detected sound, wherein the sound comprises at least body-conducted sound;
detecting, by a vibration sensor of the hearing device, mechanical vibration attributable to at least the body-conducted sound;
generating a vibration signal based on the detected mechanical vibration;
emitting output sound by a receiver of the hearing device based on a receiver input;
generating a first compensation signal by a first filter at a feedback path of the hearing device based on the in-canal audio signal;
adjusting or adapting a second filter to model a transfer function associated with the receiver input and the in-canal audio signal; and
generating a second compensation signal generated by a third filter at a feedforward signal path of the hearing device based on the vibration signal.

21. The method according to claim 20, further comprising generating the receiver input by:
subtracting the first compensation signal from the processed audio signal, and
subtracting the second compensation signal from the processed audio signal.

22. The method according to claim 20, further comprising adapting a plurality of filter coefficients of the third filter, and adapting a plurality of filter coefficients of the first filter, during initialization of the hearing device and/or normal operation of the hearing device.

23. The method according to claim 20, wherein the act of processing the ambient audio signal is performed when the hearing device is in normal operation when the hearing device is worn in or at an ear of the user, and wherein the emitted output sound is based on the processed ambient audio signal; and
wherein the method further comprises simultaneously or parallelly adapting the respective transfer functions of the first filter and the third filter.

24. The method according to claim 20, wherein the ambient microphone is configured to detect the ambient sound at an ear of the user.

25. The method according to claim 20, wherein the first compensation signal is generated to cancel at least the body-conducted sound.

26. The method according to claim 20, wherein the second filter is adjusted or adapted to model the transfer function from the receiver input to the in-canal audio signal.

27. The method according to claim 20, wherein the second compensation signal is generated to cancel at least the body-conducted sound.
